(19) United States
(12) Patent Application Publication
(10) Pub. No.: US 2012/0138600 A1
(43) Pub. Date: Jun. 7, 2012

(54) ELECTROMAGNETIC WAVE HEATING DEVICE

(75) Inventors: Yoshiharu Oomori, Shiga (JP); Tomotaka Nobue, Kyoto (JP)

(73) Assignee: Panasonic Corporation, Kadoma-shi, Osaka (JP)

(21) Appl. No.: 13/389,535

(22) PCT Filed: Aug. 10, 2010
(86) PCT No.: PCT/JP2010/005021

§ 371 Date: Feb. 8, 2012

(30) Foreign Application Priority Data
Aug. 20, 2009 (JP) 2009-190632
Jun. 21, 2010 (JP) 2010-140084

(51) Int. Cl. H05B 6/02

(52) U.S. Cl. 219/647

(57) ABSTRACT

It is an object to provide an electromagnetic-wave shield structure with a reduced size for an electromagnetic wave heating device, with a simple structure employing a meta-material formed from a lamination members including a dielectric member and conductive members laminated on each other such that the meta-material is placed in a choke slot. There are provided a heating chamber for housing a to-be-heated object, an electromagnetic-wave supply device, and a door. A choke slot and lamination members are provided in at least one of an opening peripheral portion and a door peripheral portion which is faced thereto in a state where the door is closed. This enables provision of an electromagnetic-wave shield structure with a smaller size.

### TECHNICAL FIELD

The present invention relates to electromagnetic wave heating devices having electromagnetic-wave shield structures for cutting off electromagnetic waves leaking through gaps between a heating chamber for housing to-be-heated objects and a door closing the heating chamber to the outside of the heating chamber.

### BACKGROUND ART

Conventional electromagnetic wave heating devices have generally employed “choke systems”, as electromagnetic-wave shield structures for cutting off electromagnetic waves leaking through gaps between the heating chamber and the door to the outside of the heating chamber. The “choke system” is adapted to form a choke slot at a peripheral portion of the door for opening and closing the heating chamber for attenuating electromagnetic waves leaking therefrom. The length from an opening-starting end to a short-circuiting terminal in the choke slot, which indicates the depth of the choke slot, is set to ¼ the wavelength λ of electromagnetic waves to be cut off. Since such a choke slot is formed in the door as described above, it is possible to attenuate electromagnetic waves leaking to the outside of the door from the inside of the heating chamber in the electromagnetic wave heating device, through the gap between the heating chamber and the door. Since the depth of the choke slot provided in the door is set to ¼ the electromagnetic-wave wavelength λ (=about 30 mm), the impedance Zin when viewed from the opening-starting end of the choke slot is infinite, which can attenuate electromagnetic waves leaking to the outside of the door. As described above, the “choke systems” for attenuating electromagnetic waves by using a choke slot with a depth corresponding to ¼ the electromagnetic-wave wavelength λ have also been called “λ/4 impedance inversion methods”.

As an electromagnetic-wave shield structure in a conventional electromagnetic wave heating device, other than “λ/4 impedance inversion methods”, there has been suggested a structure which includes a choke slot having different characteristic impedances at its opening-starting end and its short-circuiting terminal (refer to Patent Document 1, for example). The electromagnetic-wave shield structure disclosed in this Patent Document 1 is structured such that the choke slot has a smaller characteristic impedance at its opening-starting end than the characteristic impedance at the short-circuiting terminal. With this structure, an attempt is made to attenuate electromagnetic waves leaking to the outside of the door through the gap between the heating chamber and the door, with the choke slot having a depth smaller than ¼ the electromagnetic-wave wavelength λ.
Patent Document 1: Japanese Unexamined Patent Publication No. 59-37692

### SUMMARY OF INVENTION

### Technical Problem

However, the structure of the conventional electromagnetic wave heating device as described above has had the problem of difficulty in reducing the size of the electromagnetic-wave shield structure, as will be described later.

In the conventional electromagnetic-wave shield structure, in cases of forming, in the door, a choke slot for realizing the λ/4 impedance inversion method, it is necessary that the thickness of the door peripheral portion or the width of the door peripheral portion has a length equal to ¼ the electromagnetic-wave wavelength λ.

Further, in cases of forming the choke slot to have plural different characteristic impedances, as disclosed in Patent Document 1, the choke slot should be formed by bending a metal conductive member into a complicated shape, which results in a structure with a larger shape, thereby imposing a limit on the size reduction of the electromagnetic wave heating device.

The present invention has been made in order to solve the problems in conventional electromagnetic wave heating devices as described above and aims at forming an electromagnetic-wave shield structure capable of certainly cutting off electromagnetic waves while having a simple structure and a smaller size, for providing an electromagnetic wave heating device with a smaller size and higher reliability.

### Solution to Problem

An electromagnetic wave heating device in a first aspect of the present invention is an electromagnetic wave heating device including: a heating chamber adapted to house a to-be-heated object; a door adapted to open and close an opening portion of the heating chamber; and an electromagnetic-wave supply portion adapted to supply an electromagnetic wave to an inside of the heating chamber; wherein an electromagnetic-wave shield portion is placed between the door and a portion around the opening portion, in a state where the door closes the opening portion of the heating chamber, and the electromagnetic-wave shield portion is formed from a meta-material having a permittivity and a permeability at least one of which is set to have a predetermined value. With the electromagnetic wave heating device having the above structure in the first aspect of the present invention, it is possible to form, with a simple structure, an electromagnetic-wave shield structure capable of certainly cutting off electromagnetic waves while having a smaller size, thereby providing an electromagnetic wave heating device with a smaller size and higher reliability.

In a second aspect of the present invention, in the electromagnetic wave heating device, the electromagnetic-wave shield portion in the first aspect is constituted by a dielectric member and plural conductive members. With the electromagnetic wave heating device having the above structure in the second aspect of the present invention, it is possible to cut off electromagnetic waves with the electromagnetic-wave shield portion, as a metal-material, which is constituted by the dielectric member and the conductive members, thereby realizing an electromagnetic-wave shield structure with a simple structure and a smaller size.

In a third aspect of the present invention, in the electromagnetic wave heating device, the electromagnetic-wave shield portion in the second aspect includes a dielectric member having a flat-plate shape, and plural first conductive members having a flat-plate shape, and the plural first conductive members are placed at even intervals on the dielectric member. With the electromagnetic wave heating device having the above structure in the third aspect of the present invention, the electromagnetic-wave shield portion including the dielectric member and the plural conductive members functions as a meta-material and, further, exerts its function of cutting off leaking electromagnetic waves, which enables realizing an electromagnetic-wave shield structure with a simple structure and a smaller size.

In a fourth aspect of the present invention, in the electromagnetic wave heating device, the electromagnetic-wave shield portion in the second aspect includes a choke-slot structure forming a choke slot in a peripheral portion of the door or in a portion around the opening portion, lamination members including the dielectric member and the conductive members laminated on each other are provided within the choke slot, and the conductive members forming the lamination members are electrically connected, at least a portion thereof, to the choke-slot structure. With the electromagnetic wave heating device having the above structure in the fourth aspect of the present invention, it is possible to control the phase velocity of electromagnetic waves through the meta-material constituted by the lamination members and, further, it is possible to set the phase change in electromagnetic waves propagating within the choke slot to a desired value for inducing an impedance inversion within a shorter distance within the choke slot, thereby cutting off leaking electromagnetic waves.

In a fifth aspect of the present invention, in the electromagnetic wave heating device, the lamination members in the fourth aspect includes a dielectric member having a flat-plate shape, a first conductive member forming a capacitor in cooperation with the dielectric member, and a second conductive member forming an inductor between the first conductive member and the choke-slot structure, thereby forming the electromagnetic-wave shield portion. With the electromagnetic wave heating device having the above structure in the fifth aspect of the present invention, against electromagnetic waves propagating between the opening-starting end and the short-circuiting terminal in the choke slot, the first conductive member forms a capacitance and the second conductive member forms an inductance, and the lamination members function as a meta-material, which enables inducing an impedance inversion within a shorter distance, thereby cutting off leaking electromagnetic waves.

In a sixth aspect of the present invention, in the electromagnetic wave heating device, the second conductive member in the fifth aspect has a shape having an inductance, and the first conductive member and the second conductive member are formed integrally with each other. With the electromagnetic wave heating device having the above structure in the sixth aspect of the present invention, it is possible to easily fabricate an electromagnetic-wave shield structure which enables setting the phase change in electromagnetic waves propagating within the choke slot to a desired value for inducing an impedance inversion within a shorter distance within the choke slot, thereby cutting off leaking electromagnetic waves.

In a seventh aspect of the present invention, in the electromagnetic wave heating device, the lamination members in the fifth aspect are laminated in such a way as to form layers in a direction from an opening-starting end to a short-circuiting terminal in the choke slot. With the electromagnetic wave heating device having the above structure in the seventh aspect of the present invention, it is possible to induce an impedance inversion within the shorter distance from the opening-starting end to the short-circuiting terminal in the choke slot, thereby cutting off leaking electromagnetic waves.

In an eighth aspect of the present invention, in the electromagnetic wave heating device, the lamination members in the fifth aspect have a lamination structure including a plurality of the first conductive members such that the respective first conductive members face each other with the dielectric member interposed therebetween, and the first conductive members in an uppermost layer and a lowermost layer in the lamination structure are electrically insulated from the choke-slot structure. With the electromagnetic wave heating device having the above structure in the eighth aspect of the present invention, it is possible to set the phase change in electromagnetic waves propagating within the choke slot to a desired value for inducing an impedance inversion within a shorter distance within the choke slot, thereby cutting off leaking electromagnetic waves.

In a ninth aspect of the present invention, in the electromagnetic wave heating device, in the lamination members in the fifth aspect, the second conductive member has a zigzag shape, and the second conductive member is provided with a third conductive member having a strip shape, whereby the second conductive member has an increased area which is in contact with the choke-slot structure. With the electromagnetic wave heating device having the above structure in the ninth aspect of the present invention, it is possible to certainly cause the second conductive member to form an inductance between the first conductive member and the ground, which can cause the lamination members to function as a meta-material, thereby inducing an impedance inversion within a shorter distance and cutting off leaking electromagnetic waves.

In a tenth aspect of the present invention, in the electromagnetic wave heating device, in the lamination members in the ninth aspect, the dielectric member is adapted such that it does not come into contact with the choke-slot structure, at its end surface corresponding to the portion of the third conductive member which is in contact with the choke-slot structure. With the electromagnetic wave heating device having the above structure in the tenth aspect of the present invention, it is possible to realize an electromagnetic-wave shield structure with a simple structure and a smaller size.

In an eleventh aspect of the present invention, in the electromagnetic wave heating device, in the lamination members in the ninth aspect, a fourth conductive member having substantially the same shape as that of the third conductive member is provided, near a position corresponding to the portion at which an end surface of the dielectric member is in contact with the choke-slot structure. With the electromagnetic wave heating device having the above structure in the eleventh aspect of the present invention, it is possible to maintain the intervals between the laminated layers in the lamination members constant, which can certainly form a capacitance against electromagnetic waves propagating between the opening-starting end to the short-circuiting terminal in the choke slot, thereby causing the lamination members to function as a meta-material and inducing an impedance inversion within a shorter distance. This enables cutting off leaking electromagnetic waves. As a result thereof, with the electromagnetic wave heating device in the eleventh aspect of the present invention, it is possible to realize an electromagnetic wave heating device with a smaller size and higher reliability, while having a simple structure.

In a twelfth aspect of the present invention, in the electromagnetic wave heating device, the lamination members formed from the dielectric member and the conductive members in the fourth aspect are periodically placed in a peripheral direction within the choke slot, thereby forming the electromagnetic-wave shield portion. With the electromagnetic wave heating device having the above structure in the twelfth aspect of the present invention, against electromagnetic waves propagating in the peripheral direction through the gap between the door and a main body, the first conductive members adjacent to each other within the choke slot form capacitances therebetween, and the second conductive members form inductances, and the lamination members placed periodically within the choke slot function as a meta-material. Accordingly, in the electromagnetic wave heating device in the twelfth aspect of the present invention, the electromagnetic-wave shield portion is capable of functioning an electromagnetic band gap having a stop band corresponding to a frequency range of electromagnetic waves propagating in the peripheral direction through the gap between the door and the main body, thereby certainly cutting off leaking electromagnetic waves. Accordingly, with the electromagnetic wave heating device in the twelfth aspect of the present invention, it is possible to realize an electromagnetic-wave shield structure with a simple structure, a smaller size and higher reliability.

In a thirteenth aspect of the present invention, in the electromagnetic wave heating device, the first conductive members adjacent to each other in the peripheral direction in the electromagnetic-wave shield portion in the twelfth aspect are provided with plural protruding portions on their surfaces opposing to each other, such that the protruding portions in the first conductive members adjacent to each other are intruded into each other. With the electromagnetic wave heating device having the above structure in the thirteenth aspect of the present invention, the lamination members are placed periodically in the peripheral direction, in the gap between the door and the main body, so that the first conductive members adjacent to each other certainly form capacitors therebetween. Further, the lamination members placed periodically in the electromagnetic-wave shield portion function as a meta-material, further, function as an electromagnetic band gap, thereby cutting off leaking electromagnetic waves. As a result thereof, with the electromagnetic wave heating device in the thirteenth aspect of the present invention, it is possible to realize an electromagnetic wave heating device with a simple structure, a smaller size and higher reliability.

In a fourteenth aspect of the present invention, in the electromagnetic wave heating device, a protection dielectric member is provided such that it covers the choke slot in the fourth aspect, and the lamination members are formed integrally with the protection dielectric member. With the electromagnetic wave heating device having the above structure in the fourteenth aspect of the present invention, the meta-material constituted by the lamination members is provided integrally with the protection dielectric member for protecting the choke slot, which enables forming an electromagnetic wave shield structure with a simple structure, thereby realizing an electromagnetic wave heating device with a smaller size.

In a fifteenth aspect of the present invention, in the electromagnetic wave heating device, the electromagnetic-wave shield portion in the fifth aspect includes a fifth conductive member having a flat plate shape and having a surface facing a plurality of first conductive members with the dielectric member interposed therebetween, the fifth conductive member is periodically placed in a peripheral direction inside the choke slot, and the fifth conductive member is insulated from the choke-slot structure. With the electromagnetic wave heating device having the above structure in the fifteenth aspect of the present invention, the lamination members are placed periodically in the peripheral direction inside the choke slot, therefore, the first conductive members adjacent to each other certainly form capacitors therebetween, so that the lamination members placed periodically therein function as a meta-material. As a result thereof, in the electromagnetic wave heating device in the fifteenth aspect of the present invention, the lamination members in the electromagnetic-wave shield portion function as an electromagnetic band gap, thereby cutting off leaking electromagnetic waves. Accordingly, the electromagnetic wave heating device in the fifteenth aspect of the present invention includes an electromagnetic-wave shield structure with a smaller size and a simple structure and, thus, forms an electromagnetic wave heating device with a smaller size and higher reliability.

In a sixteenth aspect of the present invention, in the electromagnetic wave heating device, the electromagnetic-wave shield portion in the first aspect is formed from a meta-material which forms a composite right/left-handed transmission line formed from a combination of a right-handed transmission line and a left-handed transmission line. With the electromagnetic wave heating device having the above structure in the sixteenth aspect of the present invention, the electromagnetic-wave shield portion is capable of controlling the phase velocity of electromagnetic waves, thereby realizing an electromagnetic-wave shield structure with a simple structure and a smaller size.

In a seventeenth aspect of the present invention, in the electromagnetic wave heating device, the electromagnetic-wave shield portion in the sixteenth aspect includes a choke-slot structure forming a choke slot in a peripheral portion of the door or in a portion around the opening portion, and electromagnetic-wave shield members laminated inside the choke slot form a capacitance and an inductance in the left-handed transmission line. With the electromagnetic wave heating device having the above structure in the seventeenth aspect of the present invention, it is possible to form an electromagnetic wave shield structure capable of certainly cutting off electromagnetic waves while having a smaller size and a simple structure, thereby providing an electromagnetic wave heating device with a smaller size and higher reliability.

### Advantageous Effects of Invention

With the present invention, it is possible to form an electromagnetic-wave shield structure capable of certainly cutting off leaking electromagnetic waves while having a simple structure and a smaller size, thereby providing an electromagnetic wave heating device with a smaller size and higher reliability.

### BRIEF DESCRIPTION OF THE DRAWINGS

FIG. 1 is a perspective view illustrating an external appearance of an electromagnetic wave heating device according to a first embodiment of the present invention.

FIG. 2 is a cross-sectional view schematically illustrating the internal structure of the electromagnetic wave heating device according to the first embodiment.

FIG. 3 is an exploded perspective view illustrating the structure of lamination members provided inside a choke slot in the electromagnetic wave heating device according to the first embodiment.

FIG. 4 is a cross-sectional view illustrating the lamination members inside the choke slot in the electromagnetic wave heating device according to the first embodiment.

FIG. 5A is an equivalent circuit diagram of a small section in an ordinary transmission line (a right-handed transmission line) which transmits electromagnetic waves.

FIG. 5B is an equivalent circuit diagram of a small section in an ideal left-handed transmission line which transmits electromagnetic waves.

FIG. 5C is an equivalent circuit diagram of a small section in a composite right/left-handed transmission line which transmits electromagnetic waves.

FIG. 6 is a view illustrating, in an enlarging manner, a portion of a door in the electromagnetic wave heating device according to the first embodiment.

FIG. 7 is a view illustrating the structure of an electromagnetic-wave shield portion in an electromagnetic wave heating device according to a second embodiment of the present invention.

FIG. 8 is a perspective view illustrating the structure of an electromagnetic-wave shield portion in an electromagnetic wave heating device according to a third embodiment of the present invention.

FIG. 9 is a cross-sectional view of the electromagnetic-wave shield portion according to the third embodiment.

FIG. 10 is a cross-sectional view schematically illustrating the structure of an electromagnetic wave heating device according to a fourth embodiment of the present invention.

FIG. 11 is a cross-sectional view schematically illustrating the structure of an electromagnetic-wave shield portion provided between the door and a main body in the electromagnetic wave heating device according to the fourth embodiment.

FIG. 12 is a perspective view illustrating the electromagnetic-wave shield portion in the electromagnetic wave heating device according to the fourth embodiment.

FIG. 13 is a cross-sectional view illustrating the electromagnetic-wave shield portion in the electromagnetic wave heating device according to the fourth embodiment, in a state where it is provided in a door peripheral portion.

### DETAILED DESCRIPTION OF THE PREFERRED EMBODIMENTS

Hereinafter, with reference to the accompanying drawings, there will be described microwave ovens, as embodiments of an electromagnetic wave heating device according to the present invention. Further, the electromagnetic wave heating device according to the present invention is not limited to the structures of microwave ovens which will be described in the following embodiments and is intended to include electromagnetic wave heating devices structured based on technical concepts equivalent to the technical concepts which will be described in the following embodiments and based on technical common senses in the present technical field.

### First Embodiment

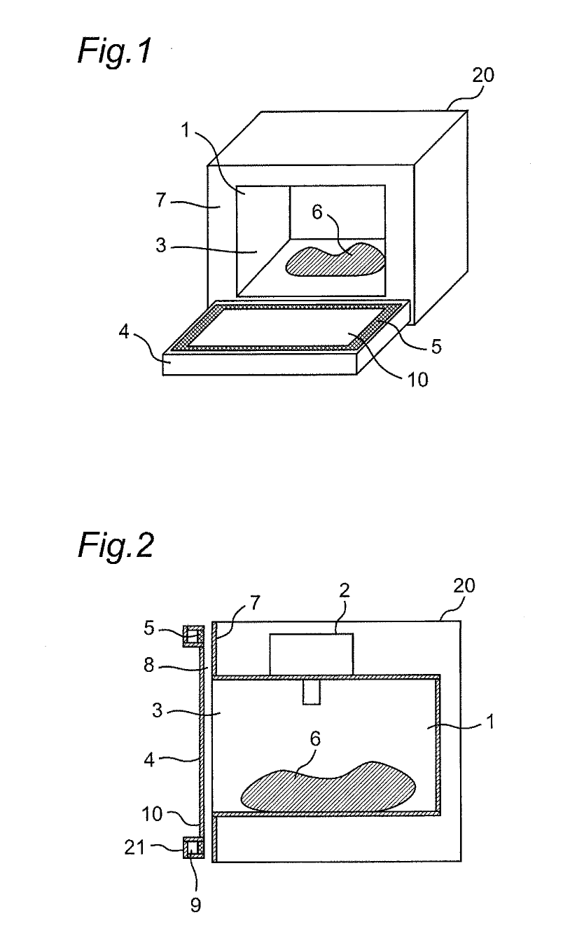

FIG. 1 is a perspective view illustrating an external appearance of a microwave oven as an electromagnetic wave heating device according to a first embodiment of the present invention, illustrating a state where a door 4 is opened to open the inside of a heating chamber 1 in a main body 20. FIG. 2 is a cross-sectional view schematically illustrating the internal structure of the microwave oven according to the first embodiment.

As illustrated in FIG. 1, by opening the openable door 4, an opening portion 3 of the heating chamber 1 having a substantially-rectangular-parallelepiped structure is opened. In a state where the opening portion 3 of the heating chamber 1 is opened, a to-be-heated object 6 is introduced into the heating chamber 1. After the door 4 is closed to close the heating chamber 1, electromagnetic waves (microwaves) with a frequency of, for example, 2400 MHz to 2500 MHz generated from an electromagnetic-wave supply portion 2 are supplied to the heating chamber 1, so that the to-be-heated object 6 housed within the heating chamber 1 is heated. Further, in FIG. 1 and FIG. 2, there is illustrated a structure which is not provided with a placement table for placing the to-be-heated object 6 thereon, but it is also possible to employ a structure provided with a placement table inside the heating chamber 1.

In the microwave oven according to the first embodiment, the heating chamber 1 has a ceiling surface, a bottom surface, a left side surface, a right side surface and a back surface, which are formed from wall plates made of metal materials. Further, an opening peripheral portion 7 around the opening portion 3 of the heating chamber 1, and the door 4 are made of metal materials. When the to-be-heated object 6 is housed within the heating chamber 1 in the main body 20, and the door 4 is closed, the electromagnetic waves supplied to the inside of the heating chamber 1 are enclosed in the inside of the heating chamber 1 having a substantially-rectangular-parallelepiped structure. However, there is induced a slight gap 8 between a door peripheral portion 10 and the opening peripheral portion 7, which may induce leakages of electromagnetic waves from the inside of the heating chamber 1 to outside of the door, through the gap 8. In FIG. 2, the gap 8 between the door 4 and the main body 20 is exaggeratedly illustrated.

In the microwave oven according to the first embodiment, the door peripheral portion 10 is provided with a choke slot 9 formed from a choke-slot structure 21, wherein the door peripheral portion 10 and the choke-slot structure 21 made of a metal material are electrically connected to each other. Inside the choke slot 9, there are provided lamination members 5 which function as a meta-material for moving forward the phases of electromagnetic waves. In a state where the door 4 is closed, the choke slot 9 formed in the door 4 is placed to surround the opening portion 3 in the main body 20, and the choke slot 9 is faced, at its opening-starting end forming an opening portion thereof, to the opening peripheral portion 7. In the first embodiment, an electromagnetic-wave shield portion is constituted by the choke-slot structure 21 having the choke slot 9, and the lamination members 5 inside the choke slot 9.

Further, while the microwave oven according to the first embodiment will be described as having a structure which provides, in the door 4, the choke slot 9 provided with the lamination members 5 as a meta-material, it is also possible to provide the choke slot 9 in the opening peripheral portion 7 around the opening portion 3 of the heating chamber 1 in the main body 20.

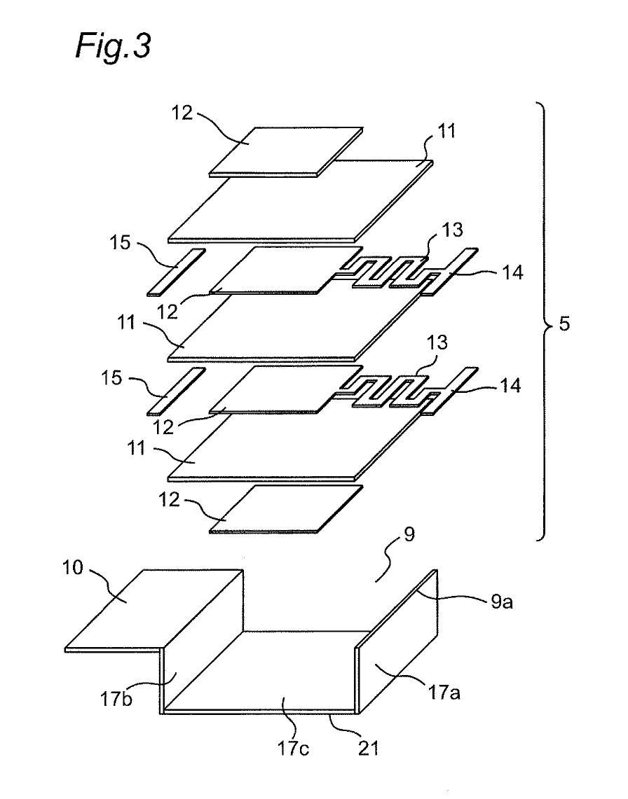

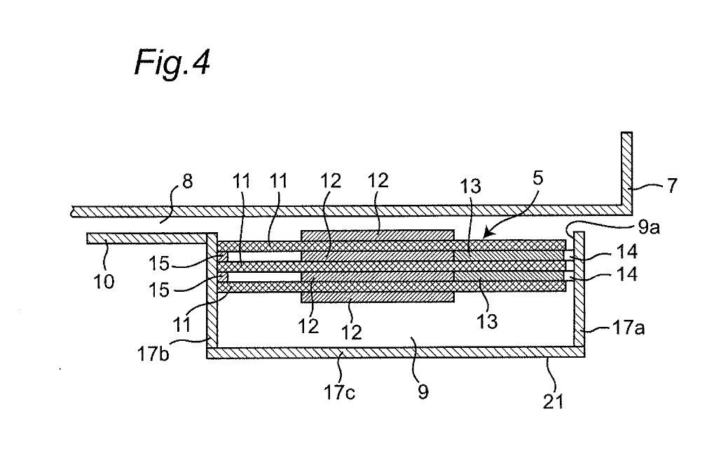

FIG. 3 is an exploded perspective view illustrating the structure of lamination members 5, as a meta-material, which is provided inside the choke slot 9, in the microwave oven according to the first embodiment. FIG. 4 is a cross-sectional view illustrating lamination members 5 inside the choke slot 9, in the microwave oven according to the first embodiment. Further, in FIG. 3 and FIG. 4, the lamination members 5 are illustrated by exaggerating its thickness, but, in actual, the lamination members 5 are constituted by thin films laminated on each other, wherein the thicknesses of the respective layers in the lamination members 5 are properly determined according to various types of conditions, such as the specifications of the microwave oven, the wavelengths of electromagnetic waves to be cut off.

As illustrated in FIG. 3 and FIG. 4, the choke-slot structure 21 is formed to have a concave shape formed by a first slot side wall 17a, a second slot side wall 17b, and a slot terminal wall (a bottom wall) 17c, in the door peripheral portion 10. The opening-starting end 9a of the choke slot 9, which forms an opening portion thereof, is faced to the opening peripheral portion 7 in the main body 20. The choke slot 9 formed as described above is provided to surround the opening portion 3 of the main body 20, such that this choke slot 9 is continuous with the door peripheral portion 10 which is a peripheral portion of the door 4.

The lamination members 5, as a meta-material, which are provided inside the choke slot 9 are constituted by plural conductive members and plural dielectric members which are laminated on each other. Hereinafter, the structure of the lamination members 5 will be described in detail.

As illustrated in FIG. 3, the lamination members 5 are constituted by dielectric members 11 forming planar-shaped thin films, and first conductive members 12 forming planar-shaped thin films which are alternately laminated on each other. At the opposite end portions of the lamination members 5 in the direction of the lamination, there are placed only first conductive members 12. As illustrated in FIG. 3, second conductive members 13 having a zigzag shape are electrically connected, at one end portions thereof, to the first conductive members 12 sandwiched between the dielectric members 11. Third conductive members 14 with a strip shape are electrically connected, at one longer-side portions thereof, to the other ends of the second conductive members 13. The third conductive members 14 are connected, at their other longer-side portions, to the first slot side wall 17a in the choke-slot structure 21. Thus, the third conductive members 14 are certainly and electrically connected, at their longer edge portions in the longitudinal direction, to the inner wall surface of the first slot side wall 17a.

As illustrated in FIG. 4, fourth conductive members 15 having a strip shape are provided, between the laminated dielectric members 11. These fourth conductive members 15 are not in contact with the first conductive members 12. That is, between the laminated dielectric members 11, the fourth conductive members 15 are placed at portions at which neither the second conductive members 13 nor the third conductive members 14 are placed. Further, the fourth conductive members 15 are formed from thin-film members having the same thickness as that of the first conductive members 12, the second conductive members 13 and the third conductive members 14.

Further, as illustrated in FIG. 4, the laminated dielectric members 11 are structured, such that they are not in contact with the first slot side wall 17a in the choke-slot structure 21, at their end portions in the side in which there are placed the second conductive members 13 and the third conductive members 14. With this structure, the third conductive members 14 are certainly in contact with the first slot side wall 17a.

On the other hand, the laminated dielectric members 11 are structured, such that they are in contact with the second slot side wall 17b in the choke-slot structure 21, at their end portions in the side in which there are placed the fourth conductive members 15.

In the lamination members 5 having the above structure, each first conductive member 12 is placed such that it substantially faces the first conductive member 12 in the next layer with a dielectric member 11 with an area larger than that of the first conductive members 12 interposed therebetween, and the plural first conductive members 12 and the plural dielectric members 11 constitute capacitors. In the uppermost layer and the lowermost layer in the lamination members 5, only the first conductive members 12 can be placed, but second conductive members 13 and third conductive members 14 can be also provided therein.

In the lamination members 5 in the choke slot 9, the second conductive members 13 having the zigzag shape electrically connect the first conductive members 12 and the first slot side wall 17a to each other, further, form inductors provided between the first conductive members 12 and the ground. Further, the first conductive members 12 and the second conductive members 13 can be formed integrally with each other, which makes it easier to fabricate them. Furthermore, the first conductive members 12, the second conductive members 13 and the third conductive members 14 can be formed integrally with one another, which further makes it easier to fabricate them.

The third conductive members 14 provide increased areas which are in contact with the first slot side wall 17a of the choke-slot structure 21, thereby certainly connecting, to the ground, one ends of the second conductive members 13 which form the inductors. The fourth conductive members 14 have substantially the same shape as that of the third conductive members 14 having the strip shape. The fourth conductive members 15 are placed on the end surfaces of the dielectric members 11 in the side which is not provided with the third conductive members 14, so that the fourth conductive members 15 maintain the intervals between the laminated layers in the lamination members 5 constant, thereby stabilizing the performance of the lamination members 5 as a meta-material.

Further, as a method for connecting the conductive members to the metal plates forming the choke-slot structure 21, it is possible to employ a connecting method which forms slots in the metal plates and fits the conductive members therein, or common connecting methods, such as welding and staking.

As the material of the dielectric members 11 in the above lamination members 5, it is possible to employ an ordinary dielectric material, and this material is properly determined according to various types of conditions, such as specifications of the microwave oven, wavelengths of electromagnetic waves to be cut off. Further, as the materials of the conductive members 12, 13, 14 and 15, it is possible to employ conductive materials such as copper foils or aluminum foils. Further, in the microwave oven according to the first embodiment, Teflon is employed as the material of the dielectric members 11, and the thickness thereof is 0.15 mm. Further, cupper foils are employed as the materials of the conductive members 12, 13, 14 and 15, and the thickness thereof is 0.03 mm.

Hereinafter, there will be described operations of the microwave oven having the above structure, as an electromagnetic wave heating device according to the first embodiment.

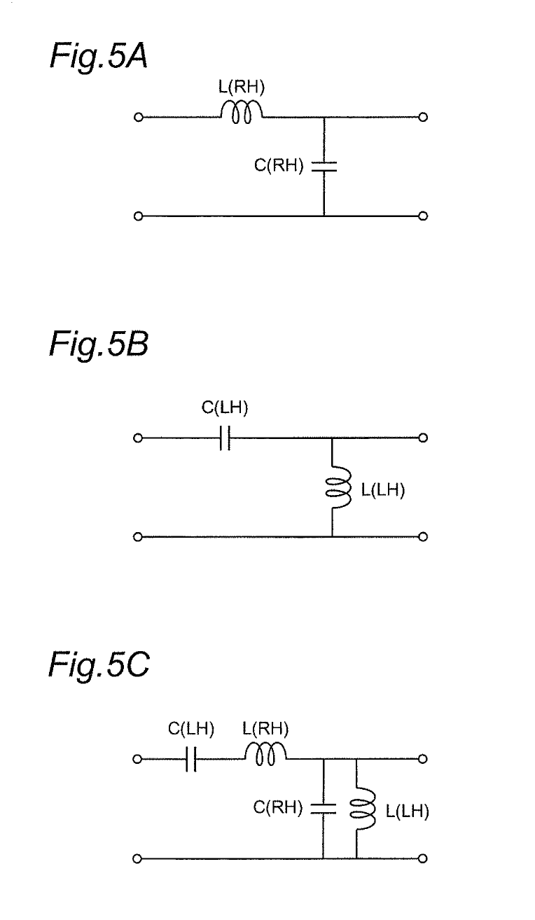

FIG. 5A is an equivalent circuit diagram of a small section in an ordinary transmission line (a right-handed transmission line) which transmits electromagnetic waves. FIG. 5B is an equivalent circuit diagram of a small section in an ideal left-handed transmission line.

In the ordinary transmission line (a right-handed transmission line; RH) which propagates electromagnetic waves, as illustrated in FIG. 5A, there is an inductance (L) in series with the transmission line, and there is a capacitance (C) in parallel with the transmission line, such that the inductance (L) and the capacitance (L) are successive and continuous. On the other hand, the ideal left-handed transmission line (a left-handed transmission line; LH) has a structure opposite from that of the equivalent circuit diagram illustrated in FIG. 5A and is constituted by a capacitance (C) in series therewith and an inductance (L) in parallel therewith (see FIG. 5B). In the ideal left-handed transmission line, the permittivity and the permeability effectively have negative values, therefore, this ideal left-handed transmission line exhibits different characteristics from those of the right-handed transmission line. However, in actual, there exists no such an ideal left-handed transmission line, and any transmission lines include a parasitic inductance (L) in series therewith, and a parasitic capacitance (C) in parallel therewith. Therefore, as illustrated in an equivalent circuit diagram in FIG. 5C, a composite right/left-handed transmission line constituted by a combination of a right-handed transmission line and a left-handed transmission line can form a transmission line capable of functioning as a meta-material.

FIG. 5C is an equivalent circuit diagram of a small section in a right/left-handed transmission line (hereinafter, abbreviated as a CRLH transmission line). The CRLH transmission line is one of common models of non-resonance type meta-materials.

If the structure of the lamination members 5 in the microwave oven according to the first embodiment is applied to the equivalent circuit diagram illustrated in FIG. 5C, the dielectric members 11 and the plural first conductive members 12 constitute a capacitance C (LH) between the layers, and the second conductive members 13 constitute an inductance (LH) between the first conductive members 12 and the ground. Further, assuming that the parasitic inductance is L (RH), and the parasitic capacitance is C (RH), in the lamination members 5, the parasitic inductance L (RH) and the parasitic capacitance C (RH) in the right-handed transmission line, together with the capacitance C (LH) and the inductance L (LH) in the left-handed transmission line, form an CRLH transmission line.

By designing the shapes of the first conductive members 12 and the second conductive members 13 constituting the lamination members 5, in the microwave oven according to the first embodiment, it is possible to induce a delay in the phase velocity of electromagnetic waves propagating through the CRLH transmission line, thereby moving forward the phase of electromagnetic waves even within a shorter distance.

In the microwave oven according to the first embodiment, electromagnetic waves leaking toward the outside of the door 4 through the gap 8 from the inside of the heating chamber 1 propagate in a left-to-right direction in the paper plane, through the gap 8 illustrated in FIG. 4, for example. A portion of electromagnetic waves propagating as described above passes by the lamination members 5 from the opening-starting end 9a of the choke slot 9 and propagates toward the inner wall surface of the slot terminal-end wall 17c, further is reflected by the inner wall surface of the slot terminal-end wall 17c forming a short-circuiting surface, then passes by the lamination members 5 again, and returns toward the opening-starting end 9a of the choke slot 9.

In the distance from the opening-starting end 9a of the choke slot 9 to the inner wall surface of the slot terminal-end wall 17c (the depth of the choke slot 9), if the phases of electromagnetic waves are changed by about λ/4, an impedance Zin when viewed from the opening-starting end 9a of the choke slot 9 is infinite, thereby substantially cutting off the electromagnetic waves propagating toward the outside of the door through the gap 8. With the structure according to the first embodiment, due to the provision of the lamination members 5 as a meta-material within the choke slot 9, it is possible to move forward the phases of electromagnetic waves propagating in the direction of the lamination of the lamination members 5, which enable substantially reducing the depth of the choke slot 9.

As described above, electromagnetic waves leaking in the direction orthogonal to the direction of the extension of the choke slot 9 (the longitudinal direction) propagate in the direction of the lamination of the lamination members 5 in the choke slot 9, and the electromagnetic waves are moved forward in phase and are substantially cut off by the choke slot with a smaller depth. On the other hand, electromagnetic waves propagating in the direction parallel to the direction of the extension of the choke slot 9 (the longitudinal direction) are substantially cut off by the choke slot 9 and by the plural lamination members 5 juxtaposed within the choke slot 9.

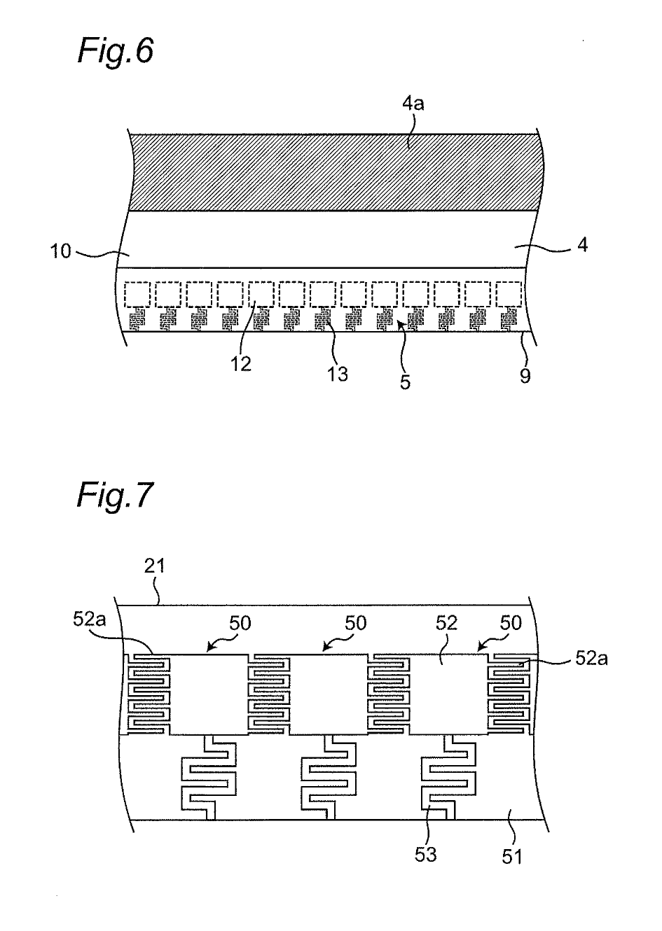

FIG. 6 is a view illustrating, in an enlarging manner, a portion of the door 4 in the microwave oven according to the first embodiment of the present invention. In FIG. 6, there is illustrated a portion of the door peripheral portion 10, wherein the door 4 is provided, at a center portion thereof, with a perforated metal 4a which enables viewing, therethrough, the inside of the heating chamber.

In the door peripheral portion 10, there is continuously formed the choke slot 9, and a plurality of the above lamination members 5 are juxtaposed within the choke slot 9. That is, in the choke slot 9 formed at the outer peripheral portion of the inner wall surface of the door 4, the plural lamination members 5 are juxtaposed, wherein the first conductive members 12 and 12 adjacent to each other form capacitances (C). Further, the second conductive members 13 having the zigzag shape form inductances (L). Inside the choke slot 9 at the peripheral portion of the door 4, there are periodically placed the plural lamination members 5 along the direction of the extension of the choke slot 9.

As described above, there are the capacitances (C) formed by the respective first conductive members 12 and 12 adjacent to each other within the choke slot 9, and there are the inductances (L) formed by the second conductive members 13. Accordingly, against electromagnetic waves propagating in the peripheral direction of the door 4 from the inside of the heating chamber 1, the capacitances (C) formed by the respective adjacent first conductive members 12 and 12 function as C (LH) in the equivalent circuits in FIG. 5, and the inductances formed by the second conductive members 13 function as L (LH) in the equivalent circuits in FIG. 5. Accordingly, against electromagnetic waves leaking in the direction of the extension of the choke slot 9 (the longitudinal direction), similarly, the lamination members 5 juxtaposed within the choke slot 9 form a CRLH transmission line, in cooperation with the parasitic inductance L (RH) and the parasitic capacitance (RH).

As described above, in the microwave oven as the electromagnetic wave heating device according to the first embodiment, since the lamination members 5 are periodically placed in the peripheral direction within the choke slot 9, the lamination members 5 function as an unbalance-type meta-material with an electromagnetic band-gap characteristic having a stop band corresponding to a frequency range, against electromagnetic waves propagating in the peripheral direction through the gap 8 between the door 4 and the main body 20. By properly designing the sizes, the shapes and the structures of the first conductive members 12 and the second conductive members 13 constituting the lamination members 5, in the microwave oven according to the first embodiment, according to specifications of this microwave oven and the like, it is possible to cause the lamination members 5 to function as an unbalance-type meta-material, thereby certainly cutting off electromagnetic waves leaking through the gap 8 between the door 4 and the main body 20.

Further, while the lamination members 5 have been described as having a structure constituted by three dielectric members 11 having a rectangular shape and four first conductive members 12 having a rectangular shape in the microwave oven according to the first embodiment, the lamination members according to the present invention are not restricted in terms of the number of layers and the shape, and the number of layers and the shapes of the lamination members are properly determined according to various types of conditions, such as the specifications and the structure of the electromagnetic wave heating device.

Further, in the microwave oven according to the first embodiment, the opening-starting end 9a of the choke slot 9 provided in the door 4 is provided with a protection dielectric member (not illustrated) for preventing intrusion of dusts and the like for protecting the lamination members 5. The lamination members 5 are formed integrally with this protection dielectric member. By forming the meta-material constituted by the lamination members integrally with the protection dielectric member for protecting the choke slot as described above, it is possible to configure an electromagnetic-wave shield structure with a simple structure, thereby providing an electromagnetic wave heating device with a small size and high reliability.

### Second Embodiment

Next, with reference to FIG. 7 attached herein, there will be described an electromagnetic wave heating device according to a second embodiment of the present invention.

FIG. 7 is a view illustrating the structure of lamination members 50 in an electromagnetic-wave shield portion in a microwave oven as the electromagnetic wave heating device according to the second embodiment. The microwave oven according to the second embodiment is different from the microwave oven according to the first embodiment, in the structure of the lamination members 50, but the other structures thereof are the same as those of the microwave oven according to the first embodiment. In the description of the second embodiment, components having the same functions and structures as those of the microwave oven according to the first embodiment will be designated by the same reference characters and will not be described herein. In the second embodiment, the electromagnetic-wave shield portion is constituted by a choke-slot structure 21 and the lamination members 50.

As illustrated in FIG. 7, in the microwave oven according to the second embodiment, the lamination members 50 are constituted by dielectric members 51 having a flat-plate shape and first conductive members 52 having a flat-plate shape which are laminated on each other. Second conductive members 53 having a zigzag shape are electrically connected, at one end portions thereof, to the first conductive members 52. The second conductive members 53 are further connected, at their other ends, to a metal plate forming the choke-slot structure 21 (corresponding to the first slot side wall 17a in the first embodiment, for example). It is also possible to provide third conductive members (14: see FIG. 3), similarly to in the first embodiment, between the second conductive members 53 and the metal plate forming the choke-slot structure 21, in order to further secure the electrical connection therebetween.

In the first conductive members 52, plural protruding portions 52a having a comb shape are formed on respective two sides opposing to each other therein. The protruding portions 52a in the first conductive members 52 are protruded toward the adjacent first conductive members 52, such that the protruding portions 52a of the first conductive members 52 adjacent to each other are intruded into each other in a staggered manner.

Inside the choke slot 9 which is continuously and peripherally formed in the door peripheral portion 10, there are periodically juxtaposed, in the peripheral direction, the lamination members 50 constituted by the dielectric-members 51 and the first conductive members 52 laminated on each other as described above.

In the microwave oven according to the second embodiment, the first conductive members 52 are structured, such that the protruding portions 52a formed on the opposing side edges thereof are intruded into the protruding portions 52a of the first conductive members 52 adjacent thereto, in a staggered manner. By determining the number, the size and the shape of the protruding portions 52a of the first conductive members 52 formed as described above, it is possible to design the capacitances between the first conductive members 52. The plural lamination members 50 having the above structure are periodically juxtaposed inside the choke slot 9. Thus, against electromagnetic waves propagating in the direction parallel to the direction of the extension of the choke slot 9 (the longitudinal direction) through the gap 8 between the door 4 and the main body 20, the capacitances C (LH) formed by the first conductive members 52 adjacent to each other, the inductances (LH) formed by the second conductive members 13 between the first conductive members 52 and the ground, parasitic inductances L (RH), and parasitic capacitances C (RH) constitute a CRHL transmission line.

The lamination members 50 placed periodically within the choke slot 9 as described above function as an unbalance-type meta-material having an electromagnetic band-gap characteristic having a stop band corresponding to a frequency range of electromagnetic waves propagating in the direction parallel to the direction of the extension of the choke slot 9 (the longitudinal direction) through the gap 8 between the door 4 and the main body 20. As a result thereof, it is possible to certainly cut off electromagnetic waves leaking from the heating chamber 1 through the gap 8 between the door 4 and the main body 20, in the microwave oven according to the second embodiment.

The lamination members 50 have been described as having a structure which includes the first conductive members 52 provided with the protruding portions 52a such that the protruding portions 52a of the first conductive members 52 adjacent to each other are intruded into each other in a staggered manner, in the microwave oven according to the second embodiment. However, in the lamination members according to the present invention, the first conductive members at an uppermost position can be provided with protruding portions such that the protruding portions of the first conductive members adjacent to each other are intruded into each other in a staggered manner, and the first conductive members therebelow can be formed similarly to the first conductive members (12) according to the first embodiment.

### Third Embodiment

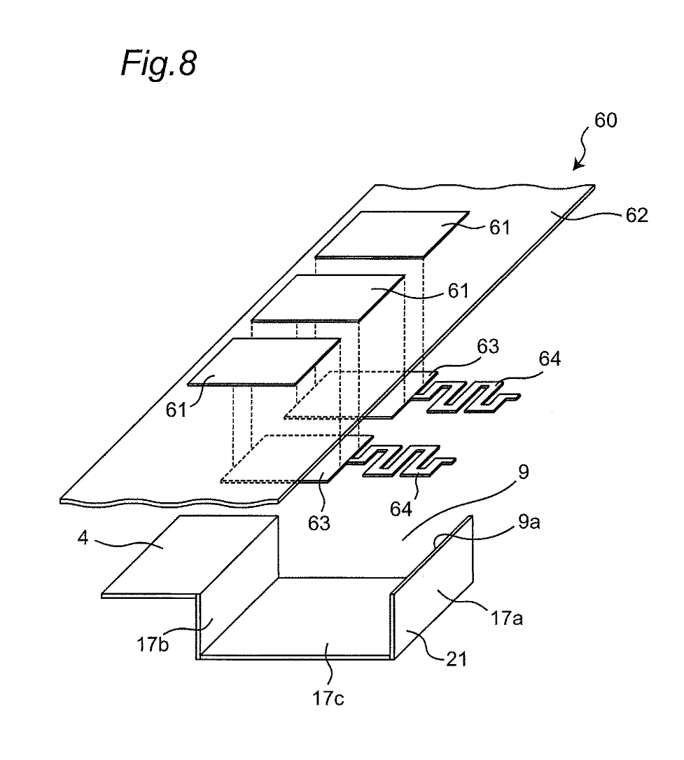

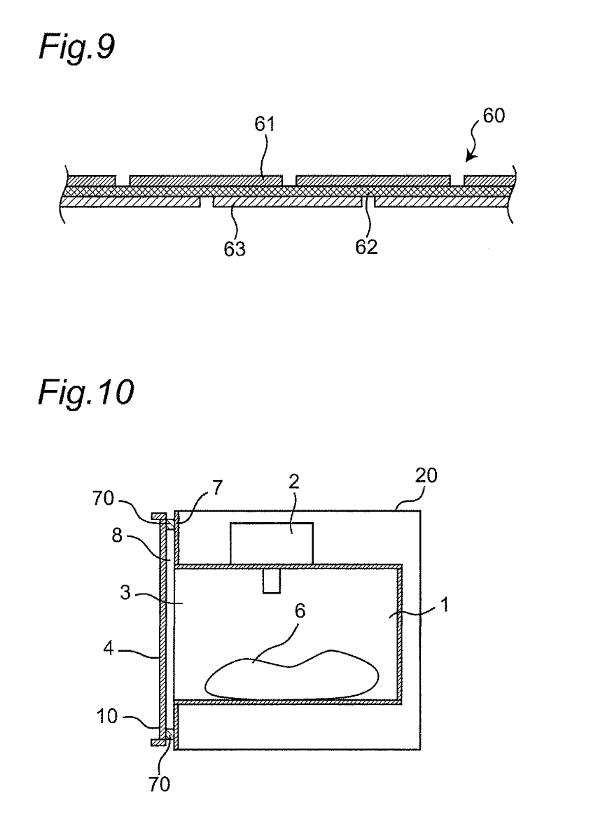

Next, with reference to FIG. 8 and FIG. 9 attached herein, there will be described an electromagnetic wave heating device according to a third embodiment of the present invention.

FIG. 8 is a perspective view illustrating the structure of lamination members 60 in a microwave oven as the electromagnetic wave heating device according to the third embodiment. FIG. 9 is a cross-sectional view of the lamination members 60 in an electromagnetic-wave shield portion according to the third embodiment. The microwave oven according to the third embodiment is different from the microwave oven according to the first embodiment, in the structure of the lamination members 60, but the other structures thereof are the same as those of the microwave oven according to the first embodiment. In the description of the third embodiment, components having the same functions and structures as those of the microwave oven according to the first embodiment will be designated by the same reference characters and will not be described herein. In the third embodiment, the electromagnetic-wave shield portion is constituted by a choke slot 9 and the lamination members 60.

As illustrated in FIG. 8, in the lamination members 60 in the microwave oven according to the third embodiment, at an uppermost position, there are juxtaposed a plurality of fifth conductive members 61 having a flat-plate shape in the direction of the extension of the choke slot 9. As a layer next to the juxtaposed fifth conductive members 61, there is placed a dielectric member 62 having a flat-plate shape. A plurality of first conductive members 63 having a flat-plate shape are juxtaposed in the direction of the extension of the choke slot 9 and are placed in the same direction as the direction of the juxtaposition of the fifth conductive members 61. As illustrated in FIG. 8 and FIG. 9, one fifth conductive member 61 is placed to straddle two first conductive members 63 and 63 with the dielectric member 62 interposed therebetween. Second conductive members 64 having a zigzag shape are electrically connected, at one end portions thereof, to the first conductive members 63. The second conductive members 64 are further connected, at their other ends, to a metal plate forming a choke-slot structure 21 (corresponding to the first slot side wall 17a in the first embodiment, for example). It is also possible to provide third conductive members (14: see FIG. 3), similarly to in the first embodiment, between the second conductive members 64 and the metal plate forming the choke-slot structure 21, in order to further ensure the electrical connection therebetween.

Further, in the third embodiment, similarly to in the first embodiment, fourth conductive members (15: see FIG. 3) can be provided, in order to maintain the intervals between the laminated layers in the lamination members constant for stabilizing the performance thereof as a meta-material.

FIG. 8 and FIG. 9 schematically illustrate the structure of the lamination members 60 in the microwave oven according to the third embodiment, wherein the lamination members 60 are illustrated as having a three-layer structure formed from the dielectric member 62 and the conductive members 61 and 63. However, the number of layers, the size and the shape of the lamination members 60 can be properly determined, according to specifications of the microwave oven, and the like, and it is possible to form lamination members having a multi-layer structure with a desired shape, using the dielectric member 62 and the conductive members 61 and 63 which have been described above.

Further, in the microwave oven according to the third embodiment, the lamination members 60 are continuously formed within the choke slot 9 formed in the door peripheral portion 10 (see FIG. 2). The fifth conductive members 61 which are the uppermost layers in the lamination members 60 are periodically placed in the peripheral direction of the door 4, within the choke slot 9.

As described above, in the lamination members 60, one fifth conductive member 61 is placed to face a plurality of first conductive members 63 (two first conductive members, in the third embodiment) with the dielectric member 62 interposed therebetween, and the first conductive members 63 adjacent to each other constitute capacitances therebetween. In the lamination members 60 according to the third embodiment, it is possible to design desired capacitances, by determining the sizes, the shapes and the like of the dielectric member 62, the first conductive members 63 and the fifth conductive members 61. Accordingly, against electromagnetic waves propagating in the direction parallel to the direction of the extension of the choke slot 9 in the door 4 (the longitudinal direction) through the gap 8 between the door 4 and the main body 20, the capacitances C (LH) formed between the plural first conductive members 63 through the fifth conductive members 61 with the dielectric member interposed therebetween, the inductances (LH) formed by the second conductive members 64 between the first conductive members 63 and the ground, parasitic inductances L (RH), and parasitic capacitances C (RH) constitute a CRHL transmission line.

The lamination members 60 which are placed periodically and continuously within the choke slot 9 as described above functions as an unbalance-type meta-material having an electromagnetic band-gap characteristic having a stop band corresponding to a frequency range of electromagnetic waves propagating in the direction parallel to the direction of the extension of the choke slot 9 (the longitudinal direction). As a result thereof, it is possible to certainly cut off electromagnetic waves leaking from the heating chamber 1 through the gap 8 between the door 4 and the main body 20, in the microwave oven according to the third embodiment.

As described above, in the electromagnetic wave heating device according to the present invention, since the lamination members constituted by the dielectric members and the conductive members laminated on each other are placed within the choke slot, as described in the first embodiment, electromagnetic waves leaking in the direction orthogonal to the direction of the extension of the choke slot (the longitudinal direction) propagate in the direction of the lamination of the lamination members within the choke slot, which can induce a delay in the phase velocity of the electromagnetic waves, thereby moving forward the phases of the electromagnetic waves even within a shorter distance. As a result thereof, with the present invention, it is possible to induce an impedance inversion within the shorter distance in the choke slot to cut off electromagnetic waves leaking therefrom, thereby realizing an electromagnetic wave heating device having an electromagnetic-wave shield structure with a smaller size and a simple structure.

Further, in the electromagnetic wave heating device according to the present invention, as described in the first to third embodiments, the lamination members, which are periodically placed within the choke slot, are adapted to function as a meta-material, against electromagnetic waves propagating in the direction parallel to the direction of the extension of the choke slot (the longitudinal direction) through the gap between the door and the main body. Accordingly, the lamination members placed periodically therein are capable of functioning as an electromagnetic band gap having a stop band corresponding to a frequency range of electromagnetic waves propagating in the direction parallel to the direction of the extension of the choke slot (the longitudinal direction). Accordingly, with the present invention, it is possible to realize, with a simple and uncomplicated structure, an electromagnetic wave heating device having an electromagnetic-wave shield structure with a smaller size and higher reliability.

Further, while, in the first to third embodiments, there have been described structures which provide the choke slot 9 in the door peripheral portion 10 and further provide the lamination members 5, 50 and 60 inside the choke slot 9, the present invention is not limited to these structures, and it is also possible to provide a choke slot in the opening peripheral portion 7 in the main body at its portion which faces the door 4 and, further, to place lamination members inside the choke slot, which can also offer the same effects.

### Fourth Embodiment

Next, with reference to FIGS. 10 to 13 attached herein, there will be described an electromagnetic wave heating device according to a fourth embodiment of the present invention.

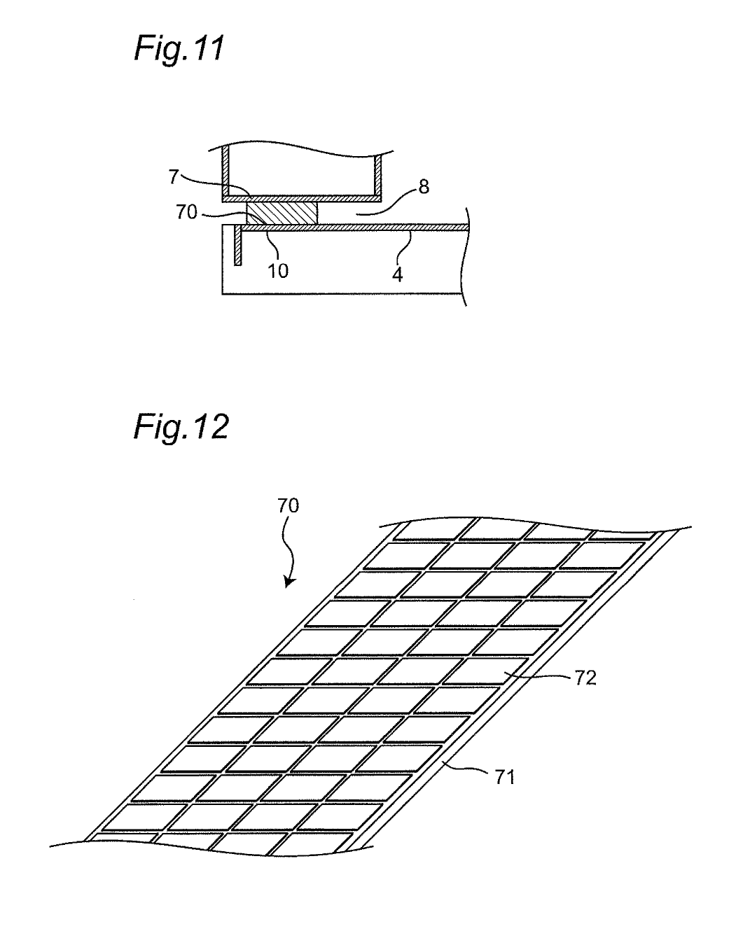

FIG. 10 is a cross-sectional view schematically illustrating the internal structure of a microwave oven as an electromagnetic wave heating device according to the fourth embodiment. FIG. 11 is a cross-sectional view schematically illustrating the structure of an electromagnetic-wave shield portion provided between a main body 20 and a door 4 in the microwave oven according to the fourth embodiment. In FIG. 10 and FIG. 11, the electromagnetic-wave shield portion 70 is illustrated by exaggerating its thickness, but the thickness of the electromagnetic-wave shield portion 70 is properly determined according to various types of conditions, such as the specifications of the microwave oven, the wavelengths of electromagnetic waves to be cut off.

The microwave oven according to the fourth embodiment is different from the microwave oven according to the first embodiment, in the structure of the electromagnetic-wave shield portion, but the other structures thereof are the same as those of the microwave oven according to the first embodiment. In the description of the fourth embodiment, components having the same functions and structures as those of the microwave oven according to the first embodiment will be designated by the same reference characters and will not be described herein.

In the microwave oven according to the fourth embodiment, there is provided the electromagnetic-wave shield portion 70 formed from a meta-material, between the door 4 and the main body 20. The electromagnetic-wave shield portion 70 is provided in a door peripheral portion 10 of the door 4 and is placed such that it faces an opening peripheral portion 7 around an opening portion 3 in the main body 20 in a state where the door 4 is closed. Namely, the electromagnetic-wave shield portion 70 is provided such that it closes the gap 8 between the door 4 and the opening peripheral portion 7 of the main body 20.

Further, while the electromagnetic-wave shield portion 70 formed from the meta-material will be described as being provided in the door peripheral portion 10, in the microwave oven according to the fourth embodiment, the electromagnetic-wave shield portion 70 can be provided in the opening peripheral portion 7 around the opening portion 3 of the heating chamber 1 in the main body 20.

In the microwave oven according to the fourth embodiment, the electromagnetic-wave shield portion 70 is placed to surround the opening portion 3 in the main body 20, such that the electromagnetic-wave shield portion 70 formed from the meta-material is faced to the opening peripheral portion 7 in the main body 20, in a state where the door 4 is closed.

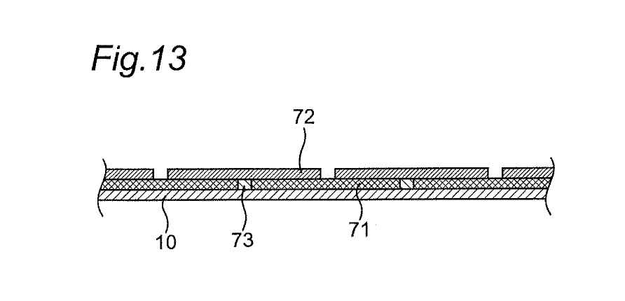

FIG. 12 is a perspective view illustrating the electromagnetic-wave shield portion 70 in the microwave oven according to the fourth embodiment. FIG. 13 is a cross-sectional view illustrating the electromagnetic-wave shield portion 70 in a state where it is provided in the door peripheral portion 10 of the door 4.

As illustrated in FIG. 12, the electromagnetic-wave shield portion 70 is constituted by a dielectric member 71 having a flat-plate shape, and a plurality of first conductive members 72 which are plate-shaped rectangular small pieces with a size sufficiently smaller than the wavelengths of to-be-used electromagnetic waves, such that the first conductive members 72 are placed on the dielectric member 71. In the electromagnetic-wave shield portion 70, the plurality of the first conductive members 72 are placed at even intervals on the flat-plate shaped dielectric member 71, and the first conductive members 72 are electrically connected, through conductive members 73, to the door peripheral portion 10 of the door 4 made of a metal. As illustrated in FIG. 13, the conductive members 73 are conductive materials embedded in through holes formed in the dielectric member 71. The structure of the electromagnetic-wave shield portion 70 can be formed by printed-circuit board fabrication techniques, for example.

In the microwave oven according to the fourth embodiment, the electromagnetic-wave shield portion 70 is a structure formed from a meta-material whose effective permittivity and permeability can be arbitrarily designed to predetermined values. By designing its permittivity and permeability to predetermined values, the impedance Zin of the electromagnetic-wave shield portion 70 can be set to be infinite. In the microwave oven according to the fourth embodiment, between the gap 8 between the door 4 and the main body 20, the electromagnetic-wave shield portion 70 having such an infinite impedance can be provided to surround the opening portion 3 of the heating chamber 1, thereby cutting off electromagnetic waves leaking to the outside of the door through the gap 8 from the heating chamber 1.

Further, in the electromagnetic wave heating device according to the present invention, the electromagnetic-wave shield portion can be formed from a metal-material designed such that its permittivity and permeability both have predetermined negative values, which causes electromagnetic waves transmitting within the electromagnetic-wave shield portion to have a phase velocity in the opposite direction from that of the group velocity, thereby causing electromagnetic waves transmitting within the electromagnetic-wave shield portion to have a phase velocity in the opposite direction from that of electromagnetic waves propagating through the gap between the electromagnetic-wave shield portion and the main body or the door.

Since electromagnetic waves transmitting within the electromagnetic-wave shield portion as a meta-material are caused to have a phase velocity in the opposite direction from that of electromagnetic waves propagating through the gap between the electromagnetic-wave shield portion and the main body or the door, it is possible to cause their electric fields to be in directions opposite from each other, which causes these electromagnetic waves to cancel each other out, thereby attenuating or cutting off these electromagnetic waves.

In the electromagnetic wave heating device according to the present invention, the electromagnetic-wave shield portion is a structure formed from a meta-material whose effective permittivity and permeability can be arbitrarily designed to predetermined values. Accordingly, by designing the permittivity and permeability of the electromagnetic-wave shield portion to predetermined values, it is possible to make the wavelengths of electromagnetic waves transmitting within the electromagnetic-wave shield portion smaller.

In the choke slot formed in the door peripheral portion of the door or in the opening peripheral portion of the main body, the length from the opening-starting end to the short-circuiting terminal (the depth of the choke slot) equals to the distance corresponding to ¼ the wavelength λ of electromagnetic waves, which causes an impedance inversion therein, thereby making the impedance when viewed from the opening-starting end infinite. This enables cutting off electromagnetic waves in the choke slot. Since the depth of the choke slot is set to λ/4, by reducing the wavelength of electromagnetic waves transmitting within the electromagnetic-wave shield portion, it is possible to reduce the depth of the choke slot, thereby realizing an electromagnetic-wave shield portion with a smaller size.

### INDUSTRIAL APPLICABILITY

With the present invention, it is possible to provide an electromagnetic-wave shield structure with a smaller size and excellent reliability, and therefore, the present invention can be applied to various types of applications, such as heating devices which utilize electromagnetic induction heating as represented by microwave ovens, garbage disposers.

### REFERENCE SIGNS LIST

1 Heating chamber
2 Electromagnetic-wave supply portion
3 Opening portion
4 Door
5 Lamination member
6 To-be-heated object
7 Opening peripheral portion
8 Gap
9 Choke slot
10 Door peripheral portion
11 Dielectric member
12 First conductive member
13 Second conductive member
14 Third conductive member
15 Fourth conductive member

1. An electromagnetic wave heating device comprising:
a heating chamber adapted to house a to-be-heated object;
a door adapted to open and close an opening portion of the heating chamber; and
an electromagnetic-wave supply portion adapted to supply an electromagnetic wave to an inside of the heating chamber;
wherein an electromagnetic-wave shield portion is placed between the door and a portion around the opening portion, in a state where the door closes the opening portion of the heating chamber, and
the electromagnetic-wave shield portion comprises a meta-material which is formed by piling up a dielectric member and a conductive member.

2. The electromagnetic wave heating device according to claim 1, wherein
the electromagnetic-wave shield portion is configured that said dielectric member is sandwiched between plural said conductive members.

3. The electromagnetic wave heating device according to claim 1, wherein said electromagnetic-wave shield portion comprises a dielectric member having a flat-plate shape, and plural first conductive members having a flat-plate shape, and the plural first conductive members are placed at even intervals on the dielectric member.

4. The electromagnetic wave heating device according to claim 2, wherein
the electromagnetic-wave shield portion includes a choke-slot structure forming a choke slot in a peripheral portion of the door or in a portion around the opening portion,
lamination members comprising the dielectric member and the conductive members laminated on each other is provided within the choke slot, and the conductive members forming the lamination members are electrically connected, at least a portion thereof, to the choke-slot structure.

5. The electromagnetic wave heating device according to claim 4, wherein
the lamination members include a dielectric member having a flat-plate shape, a first conductive member forming a capacitor in cooperation with the dielectric member, and a second conductive member forming an inductor between the first conductive member and the choke-slot structure, thereby forming the electromagnetic-wave shield portion.

6. The electromagnetic wave heating device according to claim 5, wherein
the second conductive member has a shape having an inductance, and the first conductive member and the second conductive member are formed integrally with each other.

7. The electromagnetic wave heating device according to claim 5, wherein
the lamination members are laminated in such a way as to form layers in a direction from an opening-starting end to a short-circuiting terminal in the choke slot.

8. The electromagnetic wave heating device according to claim 5, wherein
the lamination members have a lamination structure including a plurality of the first conductive members such that the respective first conductive members face each other with the dielectric member interposed therebetween, and the first conductive members in an uppermost layer and a lowermost layer in the lamination structure are electrically insulated from the choke-slot structure.

9. The electromagnetic wave heating device according to claim 5, wherein
in the lamination members, the second conductive member has a zigzag shape, and the second conductive member is provided with a third conductive member having a strip shape, whereby the second conductive member has an increased area which is in contact with the choke-slot structure.

10. The electromagnetic wave heating device according to claim 9, wherein
in the lamination members, the dielectric member is adapted such that it does not come into contact with the choke-slot structure, at its end surface corresponding to the portion of the third conductive member which is in contact with the choke-slot structure.

11. The electromagnetic wave heating device according to claim 9, wherein
in the lamination members, a fourth conductive member having substantially the same shape as that of the third conductive member is provided, near a position corresponding to the portion at which an end surface of the dielectric member is in contact with the choke-slot structure.

12. The electromagnetic wave heating device according to claim 4, wherein
the lamination members comprising the dielectric member and the conductive members are periodically placed in a peripheral direction within the choke slot, thereby forming the electromagnetic-wave shield portion.

13. The electromagnetic wave heating device according to claim 12, wherein
the first conductive members adjacent to each other in the peripheral direction in the electromagnetic-wave shield portion are provided with plural protruding portions on their surfaces opposing to each other, such that the protruding portions in the first conductive members adjacent to each other are intruded into each other.

14. The electromagnetic wave heating device according to claim 4, wherein
a protection dielectric member is provided such that it covers the choke slot, and the lamination members is formed integrally with the protection dielectric member.

15. The electromagnetic wave heating device according to claim 5, wherein
the electromagnetic-wave shield portion includes a fifth conductive member having a flat-plate shape and having a surface facing a plurality of first conductive members with the dielectric member interposed therebetween, the fifth conductive member is periodically placed in a peripheral direction inside the choke slot, and the fifth conductive member is insulated from the choke-slot structure.

16. The electromagnetic wave heating device according to claim 1, wherein
the electromagnetic-wave shield portion comprises a meta-material which forms a composite right/left-handed transmission line formed from a combination of a right-handed transmission line and a left-handed transmission line.

17. The electromagnetic wave heating device according to claim 16, wherein
the electromagnetic-wave shield portion includes a choke-slot structure forming a choke slot in a peripheral portion of the door or in a portion around the opening portion, and
electromagnetic-wave shield members laminated inside the choke slot form a capacitance and an inductance in the left-handed transmission line.
